(19) United States
(12) Patent Application Publication
(10) Pub. No.: US 2026/0300826 A1
(43) Pub. Date: Oct. 1, 2026

(54) METHODS AND SYSTEMS FOR GENERATING SYNTHETIC SENSOR TIME-SERIES DATA

(71) Applicant: TDK U.S.A. Corporation, Uniondale, NY (US)

(72) Inventors: Darby Michael LOSEY, Pittsburgh, PA (US); Juan S Mejia SANTAMARIA, San Jose, CA (US); Vishal VIJAYAKUMAR, Fremont, CA (US); Milad POOLADSANJ, Irvine, CA (US); Abbas ATAYA, Menlo Park, CA (US)

(73) Assignee: TDK U.S.A. Corporation, Uniondale, NY (US)

(21) Appl. No.: 19/559,752

(22) Filed: Mar. 6, 2026

Related U.S. Application Data
(60) Provisional application No. 63/780,122, filed on Mar. 28, 2025.

(51) Int. Cl. G06N 20/00; G05B 23/02

(52) U.S. Cl. CPC G06N 20/00; G05B 23/0283

(57) ABSTRACT

In a method for generating synthetic sensor time-series data, first sensor time-series data representing a first operating state of a system and second sensor time-series data representing a second operating state of the system are received. Synthetic sensor time-series data representing at least one intermediate operating state of the system is generated at a generative model, wherein the at least one intermediate operating state is between the first operating state and the second operating state. A machine learning model is trained using the first sensor time-series data, the second sensor time-series data, and the synthetic sensor time-series data. The machine learning model is deployed within a target operating environment, wherein the machine learning model monitors a condition of the system.

### RELATED APPLICATION

This application claims priority to and the benefit of co-pending U.S. Provisional Patent Application 63/780,122, filed on Mar. 28, 2025, entitled “PARTIAL-FAULT GENERATION FOR PREDICTIVE MAINTENANCE IN INDUSTRIAL MACHINERY,” by Losey et al., having Attorney Docket No. IVS-1164-PR, and assigned to the assignee of the present application, which is incorporated herein by reference in its entirety.

### BACKGROUND

In many industries, equipment and machinery are critical to operations, and unexpected failures can lead to significant downtime, costly repairs, and safety hazards. Traditional maintenance approaches, such as scheduled maintenance, often fail to predict and prevent these failures because they do not account for the actual condition of the equipment. In order to determine when a fault in a machine is about to occur, it is typically useful to have data from when the machine is beginning to show early signs of failure. However, it is often the case that this data is not available. In many circumstances, the only data that is available is when the machine is in a normal operating state or a faulty operating state. In this case, data from when the machine is in the process from transforming from normal operating condition to the faulty operating condition is limited or entirely unavailable.

### BRIEF DESCRIPTION OF DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a graphic representation illustrating example graphs of sensor time-series data according to different operating conditions, in accordance with embodiments described herein.

FIG. 2 is a block diagram illustrating an example system for generating synthetic sensor time-series data and performing fault detection, in accordance with embodiments.

FIG. 3 is a block diagram illustrating an example data synthesis system, in accordance with embodiments.

FIG. 4 is a block diagram illustrating an example machine learning model training system, in accordance with embodiments.

FIG. 5 is a block diagram illustrating an example fault detection module, in accordance with embodiments.

FIG. 6 is a flow diagram illustrating an example method for generating synthetic sensor time-series data, according to embodiments.

FIG. 7 is a flow diagram illustrating an example method for generating synthetic sensor time-series data using representation learning, according to embodiments.

FIG. 8 is a flow diagram illustrating an example method for generating synthetic sensor time-series data using gradient-based state-alignment perturbation, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “collecting,” “synthesizing,” “training,” determining,” “combining,” “training,” “deploying,” “generating,” “deriving,” “analyzing,” “monitoring,” “processing,” “using,” “performing,” “outputting,” “defining,” “sampling,” “decoding,” “computing,” “executing,” “capturing,” or the like, refer to the actions and processes of an electronic device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example ultrasonic sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of examples of sensor time-series data according to different operating conditions of a system. An example system for synthesizing fault data and performing fault detection is then described. An example data synthesis system is then described. An example machine learning model training system is then described. An example fault detection system for performing fault detection based on the synthesized fault data is then described. Example operations of synthesizing fault data are then described.

Mechanical equipment and machinery are critical components in numerous industrial applications, including aerospace, automotive, and energy production. Ensuring their reliability and performance is crucial, as faults in these systems can lead to catastrophic failures and costly downtime. In order to determine when a fault in a machine is about to occur, it is typically useful to have data from when the machine is beginning to show early signs of failure. In many circumstances, the only data that is available is when the machine is in a normal operating state or a faulty operating state. In these situations, data from when the machine is in the process from transforming from normal operating condition to the faulty operating condition is limited or entirely unavailable.

Embodiments described herein generate “partial fault data,” data from when the machine is in the process of breaking down but not yet in a fault condition, from data collected when the machine was in normal and faulty operating conditions. This generated data can then be used to train a condition-based monitoring (CBM) algorithm or a predictive-based monitoring algorithm in order to detect or predict machine failures in advance of such a failure, e.g., implemented within a machine learning model. Enabling this proactive approach helps in minimizing unplanned downtime, reducing maintenance costs, and enhancing overall operational efficiency.

The described embodiments address the specific technical problem of the lack of intermediate fault data necessary for effective CBM and predictive maintenance. In many cases, data is only available for machines operating under normal conditions or in a fully faulty state. This absence of data during the transition from normal to faulty conditions hinders the development of accurate predictive models. Without this intermediate data, it is challenging to identify early signs of failure and predict when a machine is likely to break down. Embodiments described herein address this need by generating partial fault data from existing normal and faulty condition data. This synthetic data fills the gap, enabling the creation of more precise and reliable algorithms for monitoring and predicting equipment failures, ultimately improving maintenance strategies and operational efficiency.

The described embodiments improve upon existing designs by addressing the limitations of data collection and algorithm training in industrial settings. Data collection for industrial machines often comes from collecting data from one or more discrete operating conditions, resulting in algorithms that do not generalize to intermediate states. This can result in missed early indicators of potential failures. In contrast, the described embodiments generates data from intermediate states, capturing the transition between states, such as the transition between normal operation and failure. This enriched dataset enhances downstream algorithm training, improving the ability of CBM algorithms to generalize. Consequently, the described embodiments allow for earlier identification of potential failures, enabling more effective preventative maintenance. Additionally, the described embodiments improve various downstream processes such as classification, anomaly detection, predictive maintenance, and forecasting, making it a comprehensive solution for industrial machine and sensor data applications.

Embodiments described herein provide a method for generating synthetic sensor time-series data. First sensor time-series data representing a first operating state of a system and second sensor time-series data representing a second operating state of the system are received. In some embodiments, the first sensor time-series data and the second sensor time-series data include real data collected by at least one sensor. In some embodiments, the first sensor time-series data and the second sensor time-series data include synthetic data. In some embodiments, the first sensor time-series data and the second sensor time-series data includes at least one of: vibration data, magnetic data, temperature data, pressure data, electric current data, and acoustic data. In some embodiments, the first sensor time-series data and the second sensor time-series data are received from a simulator configured to generate synthetic data for the first operating state and the second operating state, and wherein the generative model is configured to generate the synthetic sensor time-series data to supplement the synthetic data.

Synthetic sensor time-series data representing at least one intermediate operating state of the system is generated at a generative model, wherein the at least one intermediate operating state is between the first operating state and the second operating state. In some embodiments, the first operating state corresponds to a normal condition of the system, the second operating state corresponds to a fault condition of the system, and the at least one intermediate operating state corresponds to a partial fault condition of the system.

In some embodiments, the generative model is configured to interpolate between distributions of the first sensor time-series data and the second sensor time-series data to generate the synthetic sensor time-series data. In some embodiments, the generative model interpolates between distributions of the first sensor time-series data and the second sensor time-series data within a learned embedding space. In some embodiments, the at least one intermediate operating state is determined according to an intermediate state parameter that defines a relative position of the at least one intermediate operating state between the first operating state and the second operating state.

In some embodiments, the generative model is configured to perform representation learning along a parametric trajectory within a latent representation space comprising a first region corresponding to the first operating state and a second region corresponding to the second operating state to generate the synthetic sensor time-series data, and wherein the synthetic sensor time-series data representing the at least one intermediate operating state is sampled along the parametric trajectory. In some embodiments, the parametric trajectory is a geodesic under a specified metric.

In some embodiments, generating the synthetic sensor time-series data representing the at least one intermediate operating state of the system at the generative model includes defining the latent representation space comprising the first region corresponding to the first operating state and the second region corresponding to the second operating state. Representative latent embeddings of the first operating state and the second operating state are determined. The parametric trajectory between the representative latent embeddings is generated by interpolating along a normalized directional vector derived from a difference between the representative latent embeddings. Intermediate latent points are sampled along the parametric trajectory. The intermediate latent points are decoded into the synthetic time-series sensor data into assigned graded progression parameters indicative of the at least one intermediate operating state.

In some embodiments, the generative model is configured to perform a gradient-based state-alignment perturbation to generate the synthetic sensor time-series data. In some embodiments, a differentiable objective function is parameterized using the first sensor time-series data, wherein the synthetic sensor time-series data representing the at least one intermediate operating state is a sequence of perturbed intermediate samples constituting synthetic transition data between samples of the second sensor time-series data and samples having increased conformity to the first sensor time-series data.

In some embodiments, the generating the synthetic sensor time-series data representing the at least one intermediate operating state of the system at the generative model includes training a differentiable objective function parameterized using the first sensor time-series data. Samples of the second sensor time-series data are received. Gradients of the differentiable objective function are iteratively computed with respect to the samples of the second sensor time-series data and updates that adjust the samples of the second sensor time-series data in a direction that increases a conformity measure under the differentiable objective function are applied. A sequence of perturbed intermediate samples constituting synthetic transition data between the samples of the second sensor time-series data and samples having increased conformity to the first sensor time-series data are generated.

In some embodiments, the generative model is configured to perform partial fine-tuning to generate the synthetic sensor time-series data of the at least one intermediate operating state. In some embodiments, the generating the synthetic time-series sensor data representing at least one intermediate operating state includes executing the partial fine-tuning in which a preexisting model trained on the first sensor time-series data representing the first operating state is incrementally adapted toward the second sensor time-series data representing the second operating state. Intermediate checkpoint parameter states are captured to produce the synthetic sensor time-series data indicative of the at least one intermediate operating state.

A machine learning model is trained using the first sensor time-series data, the second sensor time-series data, and the synthetic sensor time-series data. In some embodiments, the machine learning model is configured to perform at least one of: anomaly detection, prediction of future values, or classification of an operating state of the system. In some embodiments, the machine learning model is a condition-based monitoring (CBM) machine learning model for predictive maintenance of the system by enabling fault detection and failure forecasting. The machine learning model is deployed within a target operating environment, wherein the machine learning model monitors a condition of the system.

The embodiments described herein greatly extend beyond conventional methods of synthesizing data. The described embodiments provide methods for synthesizing sensor time-series data representing intermediate operating states by utilizing available sensor time-series data of available operating states, thereby eliminating the need for costly and time-intensive physical testing, and providing for safer, more scalable, and cost-effective partial-fault data synthesis. The described embodiments also use the synthesized sensor time-series data representing intermediate operating states to perform CBM or predictive-based monitoring to detect or predict machine faults before they occur, thereby improving performance of the machines themselves.

### Example Systems for Generating Synthetic Time-Series Data and Performing Fault Detection

Example embodiments described herein provide methods and systems for generating synthetic sensor time-series data and performing fault detection. First sensor time-series data representing a first operating state of a system and second sensor time-series data representing a second operating state of the system are received. Synthetic sensor time-series data representing at least one intermediate operating state of the system is generated at a generative model, wherein the at least one intermediate operating state is between the first operating state and the second operating state. A machine learning model is trained using the first sensor time-series data, the second sensor time-series data, and the synthetic sensor time-series data. The machine learning model is deployed within a target operating environment, wherein the machine learning model monitors a condition of the system.

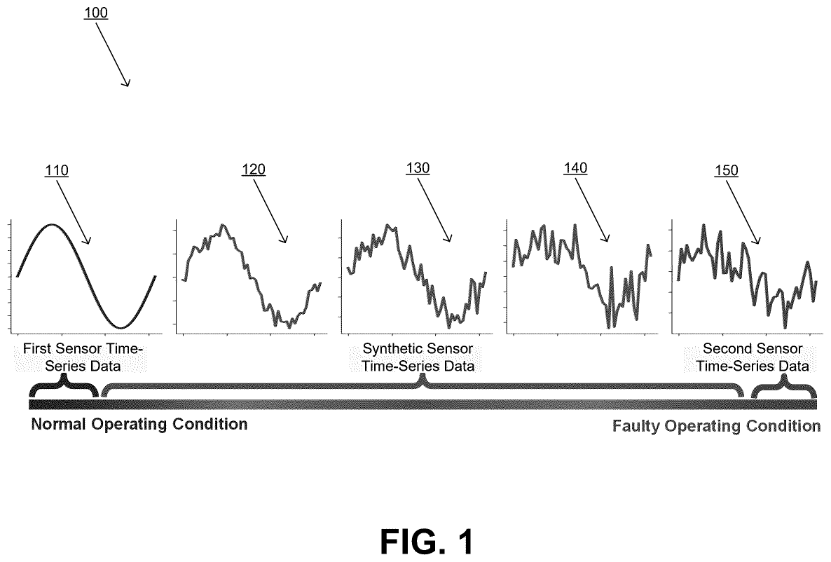

FIG. 1 is a graphic representation 100 illustrating example graphs of sensor time-series data according to different operating conditions of a system, in accordance with embodiments described herein. In accordance with the embodiments described herein, a system can include any system for which sensor time-series data can be captured, including but not limited to mechanical systems, rotor-bearing systems, motors, pumps, motors, industrial machines, etc. It should be appreciated that FIG. 1 is a graphic representation illustrating example graphs of sensor time-series data according to different operating conditions, in accordance with embodiments described herein 100 includes example visualizations of sensor time-series data according to different operating systems for purposes of explaining the described embodiments.

As illustrated, example graph 110 illustrates first sensor time-series data captured during normal operating conditions of a system and example graph 150 illustrates second sensor time-series captured during faulty operating conditions (e.g., a failure). In accordance with the described embodiments, sensor time series data during normal operating conditions and during faulty operating conditions can be captured at a sensor as real data. In some embodiments, sensor time-series data during normal operating conditions and during faulty operating conditions can include synthetic data generated to represent the desired operating conditions.

Example graphs 120, 130, and 140 illustrate sensor time-series data of intermediate operating conditions between normal operating conditions and faulty operating conditions. Embodiments described herein provide systems and methods for generating synthetic sensor time-series data representative of an intermediate operating condition based on sensor time-series data captured and/or synthesized that represent normal operating conditions and faulty operating conditions. It should be appreciated that the described embodiments provide systems and methods for generating synthetic time-series data representing intermediate operating conditions between a first operating condition (e.g., normal operating conditions) and a second operating condition (e.g., faulty operating conditions).

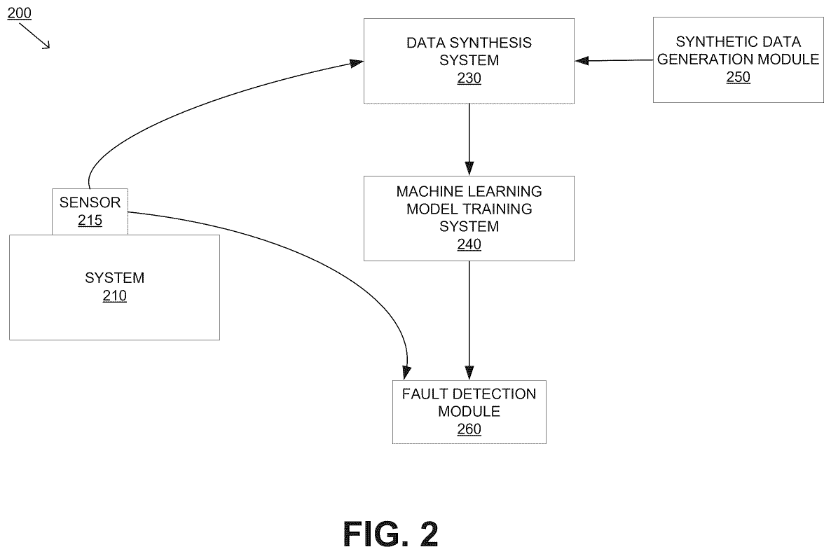

FIG. 2 is a block diagram illustrating an example system 200 for generating synthetic time-series data and performing fault detection, in accordance with embodiments. System 200 includes system 210 coupled to sensor 215, data synthesis system 230, and machine learning model training system 240. In some embodiments, system 200 also includes fault detection module 260. It should be appreciated that data synthesis system 230, machine learning model training system 240, and fault detection module 260 can be implemented as hardware, software, or any combination thereof. It should also be appreciated that data synthesis system 230, machine learning model training system 240, and fault detection module 260 may be separate components, may be comprised within a single component, or may be comprised in various combinations of multiple components, in accordance with some embodiments.

System 210 is equipment or machinery that moves during operation such that data can be collected by sensor 215. It should be appreciated that system 210 can be any time of industrial machine or equipment for which sensor time-series data can be captured, including but not limited to mechanical systems, rotor-bearing systems, motors, pumps, motors, industrial machines, etc. In some embodiments, the sensor time-series data collected by sensor 215 includes at least one of: vibration data, magnetic data, temperature data, pressure data, electric current data, and acoustic data.

Sensor 215 is coupled to system 210, and is capable of sensing vibrations from system 210 and capturing the vibrations as time-series data. It should be appreciated that, in some embodiments, sensor 215 is not directly coupled to system 210, but rather in the same environment as system 210 (e.g., factory floor or industrial complex) and is capable of sensing motion and vibrations from system 210. Sensor 215 captures time-series data when system 210 is in different and distinct operating states. For instance, sensor 215 captures time-series data while system 210 is operating under normal operating conditions (e.g., is in a healthy operating state) and while system 210 is operating under faulty operating conditions (e.g., is in a faulty operating state). As used herein, a “healthy” system refers to a system that is operating under normal operating conditions and a “faulty” system refers to a system that is operating under faulty operating conditions and is in a state of failure for purposes of performing its intended operations.

Sensor 215 includes at least one motion sensor, including without limitation: a gyroscope, an accelerometer, a magnetometer, and/or other motion sensors such as a pressure sensor and/or an ultrasonic sensor. It should be appreciated that sensor 215 can be any type of sensor capable of sensing vibrations and generating vibration data. In some embodiments, sensor 215 is comprised within a sensor processing unit (SPU). In various embodiments, sensor 215 is communicatively coupled with data synthesis system 230 via a wired or wireless interface, or other well-known means. In some embodiments, sensor 215 is communicatively coupled with machine learning model training system 240 and/or fault detection module 260 via a wired or wireless interface, or other well-known means.

In some embodiments, system 200 also includes synthetic data generation module 250 for generating time-series sensor data representative of different discrete operating states. For instance, synthetic data generation module 250 can generate sensor time-series data corresponding to a normal operating condition of a machine (e.g., system 200) and sensor time-series data corresponding to a fault condition of the system.

Data synthesis system 230 is configured to receive sensor time-series data (e.g. from sensor 215 and/or synthetic data generation module 250) and generate synthetic sensor time-series data representing at least one intermediate operating state between the operating states for which sensor time series data is received (e.g., a normal operating state and a faulty operating state). According to some embodiments, the synthetic sensor time-series data representing at least one intermediate operating state is also referred to herein as “partial fault data,” data from when the machine is in the process of breaking down but not yet in a fault condition, from data collected when the machine was in normal and faulty operating conditions. In some embodiments, data synthesis system 230 uses machine learning techniques and statistical models to generate the partial fault data. By analyzing the patterns and differences between normal and faulty condition data, the machine learning model synthesizes intermediate data that represents the transition from normal to faulty states.

In some embodiments, data synthesis system 230 also accepts a parameter that dictates the intermediate state for which synthetic sensor time-series data is to be generated, e.g., severity of the partial fault. For example, the parameter can be a value between 0 and 1, where data synthesis system 230 will produce normal-like data when the parameter is 0 and fault-like data when the algorithm is 1. When the parameter is, for example, 0.25, data synthesis system 230 would generate data had that machine been operating under a condition that was 25% of the way to a complete fault state.

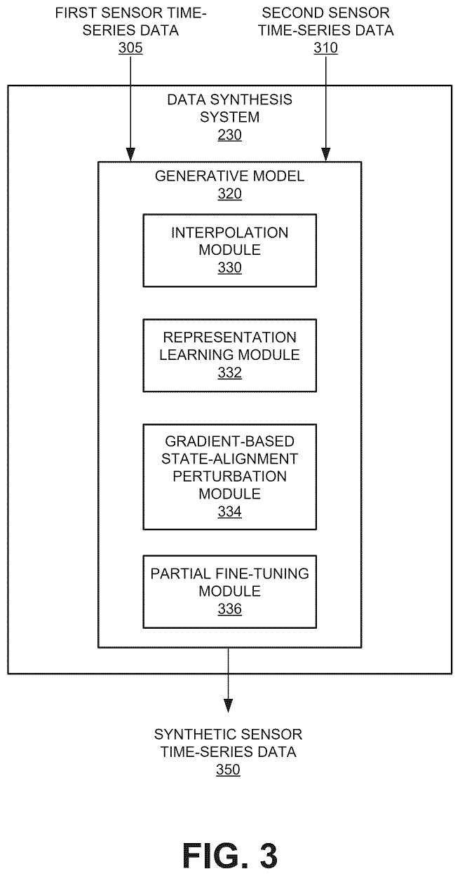

FIG. 3 is a block diagram illustrating an example data synthesis system 230, in accordance with embodiments. Data synthesis system 230 includes generative model 320 for generating synthetic sensor time-series data representing at least one intermediate operating state between the operating states for which sensor time series data is received (e.g., a normal operating state and a faulty operating state). Generative model 320 receives first sensor time-series data 305 representing a first operating state (e.g., sensor date representing a normal operating state) and second sensor time-series data 310 representing a second operating state (e.g., sensor date representing a faulty operating state). Using first sensor time-series data 305 and second sensor time-series data 310, generative model 320 is configured to generate synthetic sensor time-series data 350 representative of an intermediate state between the first operating state and the second operating state.

In some embodiments, generative model 320 is configured to incorporate physics-based constraints, domain knowledge, and pretraining on related tasks to generate the synthetic sensor time-series data of the at least one intermediate operating state. In some embodiments, generative model 320 includes at least one of: a temporal generative adversarial network (GAN), a recurrent variational autoencoder (VAE), a transformer-based sequence model, a deep neural network, and a function approximator capable of modeling complex sensor data distributions. In some embodiments, generative model 320 incorporates at least one of a recurrent, a convolutional, and a state-space architecture, to account for and incorporate temporal dependencies.

According to various embodiments, generative model 320 includes at least one of interpolation module 330, representation learning module 332, gradient-based state-alignment perturbation module 334, and partial fine-tuning module 336 for generating synthetic sensor time-series data 350. It should be appreciated that generative model 320 can use at least one or more of interpolation module 330, representation learning module 332, gradient-based state-alignment perturbation module 334, and partial fine-tuning module 336, alone or in combination, in generating synthetic sensor time-series data 350.

Interpolation module 330 is configured to interpolate between distributions of first sensor time-series data 305 and second sensor time-series data 310 to generate synthetic sensor time-series data 350. In some embodiments, interpolation module 330 is configured to interpolate between distributions of first sensor time-series data 305 and second sensor time-series data 310 within a learned embedding space to generate synthetic sensor time-series data 350. In some embodiments, at least one intermediate operating state is determined according to an intermediate state parameter that defines a relative position of the at least one intermediate operating state between the first operating state and the second operating state. It should be appreciated that the interpolation can be linear or non-linear interpolation.

Representation learning module 332 is configured to perform representation learning along a parametric trajectory within a latent representation space comprising a first region corresponding to the first operating state and a second region corresponding to the second operating state to generate synthetic sensor time-series data 350. Synthetic sensor time-series data 350 representing the at least one intermediate operating state is sampled along the parametric trajectory. In some embodiments, the parametric trajectory is a geodesic under a specified metric.

In some embodiments, representation learning module 332 projects data from first sensor time-series data 305 and second sensor time-series data 310 into a representational space that encapsulates statistical/dynamical properties of the data. Such an example of a representational space is one that is learned by an autoencoder algorithm. First sensor time-series data 305 and second sensor time-series data 310 is then projected into this representational space. Partial fault data is then generated as synthetic sensor time-series data 350 by creating a trajectory between these two datapoints in the representational space. A point along this trajectory is then sampled, in accordance with the severity parameter, and this data is then projected back to the original data space.

In some embodiments, a latent representation space including the first region corresponding to the first operating state and the second region corresponding to the second operating state is defined. Representative latent embeddings of the first operating state and the second operating state are determined. The parametric trajectory between the representative latent embeddings is generated by interpolating along a normalized directional vector derived from a difference between the representative latent embeddings. Intermediate latent points are sampled along the parametric trajectory. The intermediate latent points are decoded into synthetic time-series sensor data 350 into assigned graded progression parameters indicative of the at least one intermediate operating state.

Gradient-based state-alignment perturbation module 334 is configured to perform a gradient-based state-alignment perturbation to generate the synthetic sensor time-series data. In some embodiments, a differentiable objective function is parameterized using first sensor time-series data 305, wherein synthetic sensor time-series data 350 representing the at least one intermediate operating state is a sequence of perturbed intermediate samples constituting synthetic transition data between samples of second sensor time-series data 310 and samples having increased conformity to the first sensor time-series data 305.

In some embodiments, a differentiable objective function parameterized is trained using first sensor time-series data 305. Samples of second sensor time-series data 310 are received. Gradients of the differentiable objective function are iteratively computed with respect to the samples of second sensor time-series data 310 and updates that adjust the samples of second sensor time-series data 310 in a direction that increases a conformity measure under the differentiable objective function are applied. A sequence of perturbed intermediate samples constituting synthetic transition data between the samples of second sensor time-series data 310 and samples having increased conformity to first sensor time-series data 305 are generated as synthetic sensor time-series data 350. In some embodiments, the differentiable objective function includes a likelihood, score, distance, or reconstruction conformity term derived from the first operating state data and a regularization term penalizing deviation of the perturbed samples from the original second operating state samples beyond a prescribed norm or divergence threshold.

In some embodiments, gradient-based state-alignment perturbation module 334 enforces one or more constraints such as: maximum cumulative perturbation magnitude, support constraints tied to permissible value ranges, or termination upon satisfaction of a convergence criterion. In some embodiments, each iterative update is step-size controlled by an adaptive schedule that reduces the step size upon detection of non-monotonic improvement in the conformity measure, and halts further perturbation when a perturbation budget or convergence threshold is met.

For example, gradient-based state-alignment perturbation module 334 is trained on data from second sensor time-series data 310 representing a faulty operating condition. Example data points from first sensor time-series data 305 representing a normal operating condition are sampled. The sample data points from first sensor time-series data 305 are perturbed along a gradient defined by the gradient-based state-alignment perturbation module 334 (e.g., loglikelihood). This perturbed sample is synthetic sensor time-series data (e.g., partial fault data), with the degree of perturbation relating to the severity of the desired partial fault. It should be appreciated that gradient-based state-alignment perturbation module 334 can also be trained on first sensor time-series data 305 representing a normal operating condition and perturbing sampled data from second sensor time-series data 310.

Partial fine-tuning module 336 is configured to perform partial fine-tuning to generate synthetic sensor time-series data 350 of the at least one intermediate operating state. In some embodiments, a preexisting model trained on first sensor time-series data 305 representing the first operating state is incrementally adapted toward second sensor time-series data 310 representing the second operating state. Intermediate checkpoint parameter states are captured to produce synthetic sensor time-series data 350 indicative of the at least one intermediate operating state. In some embodiments, partial fine-tuning module 336 selectively updates a restricted subset of parameters, adapter modules, or low-rank update factors.

With reference to FIG. 2, in some embodiments, machine learning model training system 240 is configured to train a machine learning model based on first sensor time-series data 305, second sensor time-series data 310, and synthetic sensor time-series data 350.

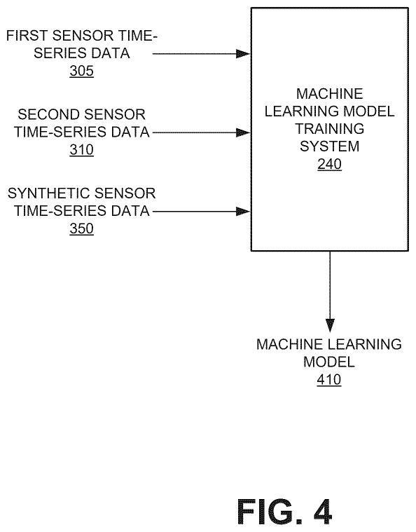

FIG. 4 is a block diagram illustrating an example machine learning model training system 240, in accordance with embodiments. Machine learning model training system 240 is configured to train machine learning model 410 using first sensor time-series data 305, second sensor time-series data 310, and synthetic sensor time-series data 350. Machine learning model 410 can be deployed (e.g., to receive sensor data from system 210) to perform fault detection on system 210. The described embodiments provide for meaningful training of machine learning model 410 by generating synthetic sensor time-series data 350 representing an intermediate operating state (e.g., a partial fault state). It should be appreciated that machine learning model training system 240 can train any number of machine learning models 410, with each being trained to identify a particular intermediate state.

In some embodiments, machine learning model 410 is configured to perform at least one of: anomaly detection, prediction of future values, or classification of an operating state of the system. In some embodiments, machine learning model 410 is a condition-based monitoring (CBM) machine learning model for predictive maintenance of the system (e.g., system 200) by enabling fault detection and failure forecasting.

With reference to FIG. 2, in some embodiments, system 200 also includes fault detection module 260 including a proxy machine learning model to perform the fault detection on system 210 on collected sensor time-series data.

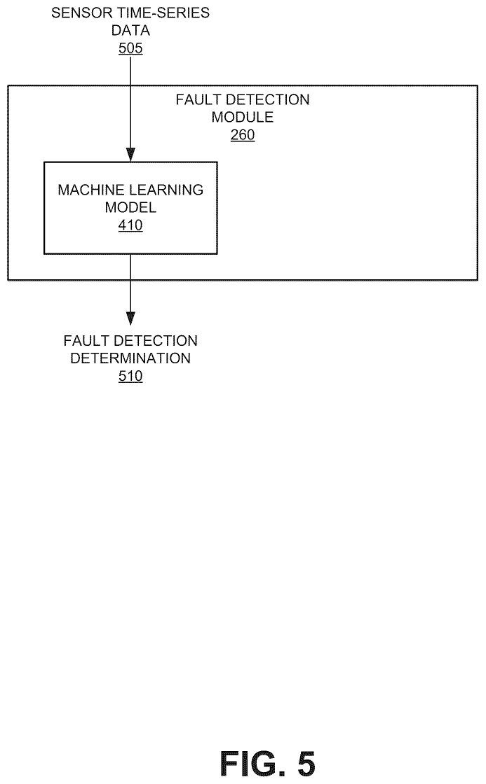

FIG. 5 is a block diagram illustrating example fault detection module 260, in accordance with embodiments. Fault detection module 260 includes machine learning model 410, which is trained to identify an intermediate state (e.g., partial fault state) between a normal operating state and a faulty operating state. It should be appreciated that fault detection module 260 can include any number of machine learning models 410, with each being trained to identify a particular intermediate state.

Machine learning model 410 receives sensor time-series data 505. It should be appreciated that sensor time-series data 505 can be received from a sensor (e.g., sensor 215) or from another sensor in the target environment. Machine learning model 410 performs fault detection and diagnosis on sensor time-series data 505, and generates fault detection determination 510 (e.g., the system is healthy and operating under normal conditions, the system is experiencing a fault event, or the system is experiencing a partial fault event).

### Example Methods of Operation

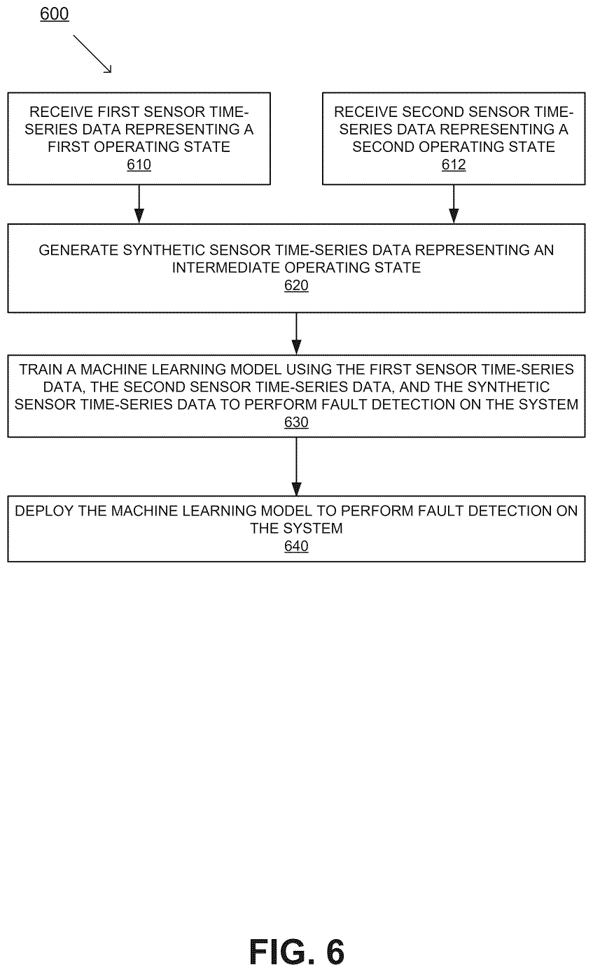

The following discussion sets forth in detail the operation of some example methods of operation of embodiments. With reference to FIGS. 6 through 8, flow diagrams 600, 700, and 800 illustrate example procedures used by various embodiments. Flow diagrams 600, 700, and 800 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control, or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited for performing various other procedures or variations of the procedures recited in the flow diagram. Likewise, in some embodiments, the procedures in the flow diagram may be performed in an order different than presented and/or not all the procedures described in the flow diagram may be performed. It is further appreciated that procedures described in the flow diagrams may be implemented in hardware, or a combination of hardware with firmware and/or software provided by a computer system.

FIG. 6 is a flow diagram 600 illustrating an example method for generating synthetic sensor time-series data, according to embodiments. At procedure 610 of flow diagram 600, first sensor time-series data representing a first operating state of a system is received. At procedure 612, second sensor time-series data representing a second operating state of the system is received. In some embodiments, the first sensor time-series data and the second sensor time-series data include real data collected by at least one sensor. In some embodiments, the first sensor time-series data and the second sensor time-series data include synthetic data. In some embodiments, the first sensor time-series data and the second sensor time-series data includes at least one of: vibration data, magnetic data, temperature data, pressure data, electric current data, and acoustic data. In some embodiments, the first sensor time-series data and the second sensor time-series data are received from a simulator configured to generate synthetic data for the first operating state and the second operating state, and wherein the generative model is configured to generate the synthetic sensor time-series data to supplement the synthetic data.

At procedure 620, synthetic sensor time-series data representing at least one intermediate operating state of the system is generated at a generative model, wherein the at least one intermediate operating state is between the first operating state and the second operating state. In some embodiments, the first operating state corresponds to a normal condition of the system, the second operating state corresponds to a fault condition of the system, and the at least one intermediate operating state corresponds to a partial fault condition of the system.

In some embodiments, the generative model is configured to interpolate between distributions of the first sensor time-series data and the second sensor time-series data to generate the synthetic sensor time-series data. In some embodiments, the generative model interpolates between distributions of the first sensor time-series data and the second sensor time-series data within a learned embedding space. In some embodiments, the at least one intermediate operating state is determined according to an intermediate state parameter that defines a relative position of the at least one intermediate operating state between the first operating state and the second operating state.

In some embodiments, the generative model is configured to perform representation learning along a parametric trajectory within a latent representation space comprising a first region corresponding to the first operating state and a second region corresponding to the second operating state to generate the synthetic sensor time-series data, and wherein the synthetic sensor time-series data representing the at least one intermediate operating state is sampled along the parametric trajectory. In some embodiments, the parametric trajectory is a geodesic under a specified metric.

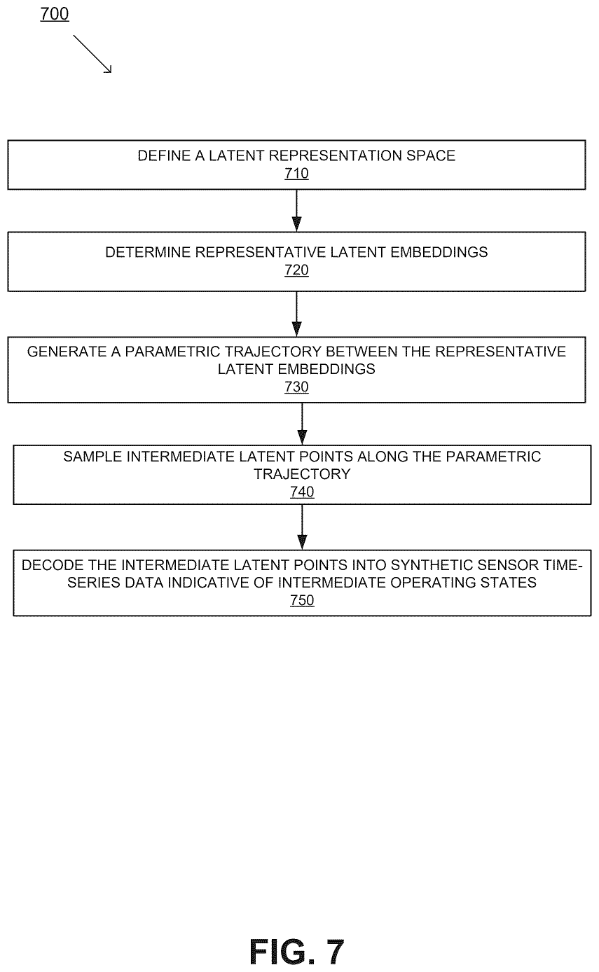

In some embodiments, procedure 630 is performed according to procedures of flow diagram 700 of FIG. 7. FIG. 7 is a flow diagram 700 illustrating an example method for generating synthetic sensor time-series data using representation learning, according to embodiments. At procedure 710 of flow diagram 700, the latent representation space comprising the first region corresponding to the first operating state and the second region corresponding to the second operating state is defined. At procedure 720, representative latent embeddings of the first operating state and the second operating state are determined. At procedure 730, the parametric trajectory between the representative latent embeddings is generated by interpolating along a normalized directional vector derived from a difference between the representative latent embeddings. At procedure 740, intermediate latent points are sampled along the parametric trajectory. At procedure 750, the intermediate latent points are decoded into the synthetic time-series sensor data into assigned graded progression parameters indicative of the at least one intermediate operating state.

With reference to FIG. 6, in some embodiments, the generative model is configured to perform a gradient-based state-alignment perturbation to generate the synthetic sensor time-series data. In some embodiments, a differentiable objective function is parameterized using the first sensor time-series data, wherein the synthetic sensor time-series data representing the at least one intermediate operating state is a sequence of perturbed intermediate samples constituting synthetic transition data between samples of the second sensor time-series data and samples having increased conformity to the first sensor time-series data.

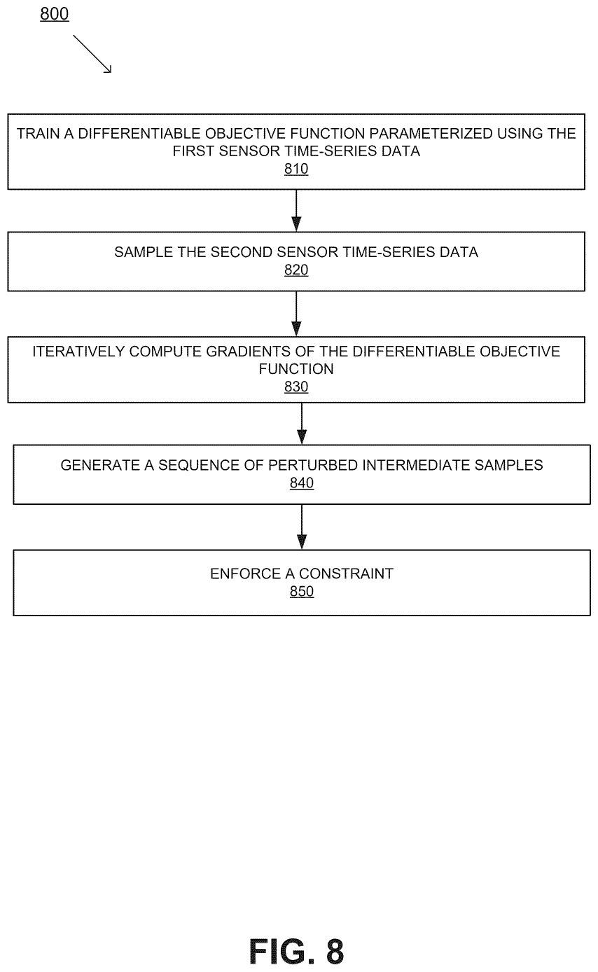

In some embodiments, procedure 630 is performed according to procedures of flow diagram 800 of FIG. 8. FIG. 8 is a flow diagram 800 illustrating an example method for generating synthetic sensor time-series data using gradient-based state-alignment perturbation, according to embodiments. At procedure 810 of flow diagram 800, a differentiable objective function parameterized using the first sensor time-series data is trained. In some embodiments, the differentiable objective function includes a likelihood, score, distance, or reconstruction conformity term derived from the first operating state data and a regularization term penalizing deviation of the perturbed samples from the original second operating state samples beyond a prescribed norm or divergence threshold.

At procedure 820, samples of the second sensor time-series data are received. At procedure 830, gradients of the differentiable objective function are iteratively computed with respect to the samples of the second sensor time-series data and updates that adjust the samples of the second sensor time-series data in a direction that increases a conformity measure under the differentiable objective function are applied. In some embodiments, each iterative update is step-size controlled by an adaptive schedule that reduces the step size upon detection of non-monotonic improvement in the conformity measure, and halts further perturbation when a perturbation budget or convergence threshold is met. At procedure 840, a sequence of perturbed intermediate samples constituting synthetic transition data between the samples of the second sensor time-series data and samples having increased conformity to the first sensor time-series data are generated. In some embodiments, as shown at procedure 850, one or more constraints are enforced, wherein the constraints include at least one of: maximum cumulative perturbation magnitude, support constraints tied to permissible value ranges, and termination upon satisfaction of a convergence criterion.

With reference to FIG. 6, in some embodiments, the generative model is configured to perform partial fine-tuning to generate the synthetic sensor time-series data of the at least one intermediate operating state. In some embodiments, the generating the synthetic time-series sensor data representing at least one intermediate operating state includes executing the partial fine-tuning in which a preexisting model trained on the first sensor time-series data representing the first operating state is incrementally adapted toward the second sensor time-series data representing the second operating state. Intermediate checkpoint parameter states are captured to produce the synthetic sensor time-series data indicative of the at least one intermediate operating state.

At procedure 630, a machine learning model is trained using the first sensor time-series data, the second sensor time-series data, and the synthetic sensor time-series data. In some embodiments, the machine learning model is configured to perform at least one of: anomaly detection, prediction of future values, or classification of an operating state of the system. In some embodiments, the machine learning model is a condition-based monitoring (CBM) machine learning model for predictive maintenance of the system by enabling fault detection and failure forecasting. At procedure 640, the machine learning model is deployed within a target operating environment, wherein the machine learning model monitors a condition of the system.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

1. A method for generating synthetic sensor time-series data, the method comprising:
receiving first sensor time-series data representing a first operating state of a system;
receiving second sensor time-series data representing a second operating state of the system;
generating synthetic sensor time-series data representing at least one intermediate operating state of the system at a generative model, wherein the at least one intermediate operating state is between the first operating state and the second operating state;
training a machine learning model using the first sensor time-series data, the second sensor time-series data, and the synthetic sensor time-series data; and
deploying the machine learning model within a target operating environment, wherein the machine learning model monitors a condition of the system.

2. The method of claim 1, wherein the first operating state corresponds to a normal condition of the system, the second operating state corresponds to a fault condition of the system, and the at least one intermediate operating state corresponds to a partial fault condition of the system.

3. The method of claim 1, wherein the generative model is configured to interpolate between distributions of the first sensor time-series data and the second sensor time-series data to generate the synthetic sensor time-series data.

4. The method of claim 3, wherein the generative model interpolates between distributions of the first sensor time-series data and the second sensor time-series data within a learned embedding space.

5. The method of claim 3, wherein the at least one intermediate operating state is determined according to an intermediate state parameter that defines a relative position of the at least one intermediate operating state between the first operating state and the second operating state.

6. The method of claim 1, wherein the generative model is configured to perform representation learning along a parametric trajectory within a latent representation space comprising a first region corresponding to the first operating state and a second region corresponding to the second operating state to generate the synthetic sensor time-series data, and wherein the synthetic sensor time-series data representing the at least one intermediate operating state is sampled along the parametric trajectory.

7. The method of claim 6, wherein the parametric trajectory is a geodesic under a specified metric.

8. The method of claim 6, wherein the generating the synthetic sensor time-series data representing the at least one intermediate operating state of the system at the generative model comprises:
defining the latent representation space comprising the first region corresponding to the first operating state and the second region corresponding to the second operating state;
determining representative latent embeddings of the first operating state and the second operating state;
generating the parametric trajectory between the representative latent embeddings by interpolation along a normalized directional vector derived from a difference between the representative latent embeddings;
sampling intermediate latent points along the parametric trajectory; and
decoding the intermediate latent points into the synthetic time-series sensor data into assigned graded progression parameters indicative of the at least one intermediate operating state.

9. The method of claim 1, wherein the generative model is configured to perform a gradient-based state-alignment perturbation to generate the synthetic sensor time-series data.

10. The method of claim 9, wherein a differentiable objective function is parameterized using the first sensor time-series data, wherein the synthetic sensor time-series data representing the at least one intermediate operating state is a sequence of perturbed intermediate samples constituting synthetic transition data between samples of the second sensor time-series data and samples having increased conformity to the first sensor time-series data.

11. The method of claim 9, wherein the generating the synthetic sensor time-series data representing the at least one intermediate operating state of the system at the generative model comprises:
training a differentiable objective function parameterized using the first sensor time-series data;
receiving samples of the second sensor time-series data;
iteratively computing gradients of the differentiable objective function with respect to the samples of the second sensor time-series data and applying updates that adjust the samples of the second sensor time-series data in a direction that increases a conformity measure under the differentiable objective function; and
generating a sequence of perturbed intermediate samples constituting synthetic transition data between the samples of the second sensor time-series data and samples having increased conformity to the first sensor time-series data.

12. The method of claim 1, wherein the generative model is configured to perform partial fine-tuning to generate the synthetic sensor time-series data of the at least one intermediate operating state.

13. The method of claim 12, wherein generating the synthetic time-series sensor data representing at least one intermediate operating state comprises:
executing the partial fine-tuning in which a preexisting model trained on the first sensor time-series data representing the first operating state is incrementally adapted toward the second sensor time-series data representing the second operating state; and
capturing intermediate checkpoint parameter states to produce the synthetic sensor time-series data indicative of the at least one intermediate operating state.

14. The method of claim 1, wherein the first sensor time-series data and the second sensor time-series data comprise real data collected by at least one sensor.

15. The method of claim 1, wherein the first sensor time-series data and the second sensor time-series data comprise synthetic data.

16. The method of claim 1, wherein the first sensor time-series data and the second sensor time-series data comprises at least one of: vibration data, magnetic data, temperature data, pressure data, electric current data, and acoustic data.

17. The method of claim 1, wherein the first sensor time-series data and the second sensor time-series data are received from a simulator configured to generate synthetic data for the first operating state and the second operating state, and wherein the generative model is configured to generate the synthetic sensor time-series data to supplement the synthetic data.

18. The method of claim 1, wherein the machine learning model is configured to perform at least one of: anomaly detection, prediction of future values, or classification of an operating state of the system.

19. The method of claim 1, wherein the machine learning model is a condition-based monitoring (CBM) machine learning model for predictive maintenance of the system by enabling fault detection and failure forecasting.

20. A non-transitory computer readable storage medium having computer readable program code stored thereon of a method for generating synthetic sensor time-series data, the method comprising:
receiving first sensor time-series data representing a first operating state of a system;
receiving second sensor time-series data representing a second operating state of the system;
generating synthetic sensor time-series data representing at least one intermediate operating state of the system at a generative model, wherein the at least one intermediate operating state is between the first operating state and the second operating state;
training a machine learning model using the first sensor time-series data, the second sensor time-series data, and the synthetic sensor time-series data; and
deploying the machine learning model within a target operating environment, wherein the machine learning model monitors a condition of the system.
